(19) United States
(12) Patent Application Publication
(10) Pub. No.: US 2003/0143021 A1
(43) Pub. Date: Jul. 31, 2003

(54) Knob attach and release mechanism for stick shift of a vehicle

(75) Inventor: Douglas S. Whalen, Freeport, IL (US)

Correspondence Address: Rene A. Vazquez, Esq., Fleshner & Kim, LLP, 14500 Avion Parkway, Suite 125, Chantilly, VA, 20151, US

(73) Assignee: Whalen Machine Inc., Freeport, IL (US)

(21) Appl. No.: 10/058,562

(22) Filed: Jan. 28, 2002

(51) Int. Cl. B25G 3/18

(52) U.S. Cl. 403/322.2

(57) ABSTRACT

A quick attach and release mechanism for shift knobs that may utilize the existing groove retention structure on stick shift shafts of vehicles. A shift knob assembly comprises a mounting sleeve secured to the shift knob. The mounting sleeve slides onto the stick shift for support. The mounting sleeve has holes extending laterally through sleeve that aligns with the retaining groove of the stick shift shaft. The hole has a retaining lip at one end that retains a ball in the hole. A retaining sleeve coaxial about the mounting sleeve is axially slidable relative to the mounting sleeve between attach and release positions. The retaining sleeve has an eccentric surface control whether the retaining ball engages or disengages the retention groove of the stick shift shaft. A coil spring urges the retaining sleeve toward the attach position.

### FIELD OF THE INVENTION

The present invention relates generally to shift knob assemblies, and more particularly relates to retention mechanisms of shift knob assemblies for attaching and releasing a shift knob from the stick shift shaft of a vehicle.

### BACKGROUND OF THE INVENTION

Stick shift knobs are mounted on the stick shift shaft of vehicles to allow for manual shifting of the gears of the transmission of the vehicle.

One of the common types of stick shift shafts includes a retention groove that provides a means for retaining or securing the stick shift knob on the shaft. Many of the BMW® vehicles have this type of a retention structure. The manufacturer of knobs for these types of shafts uses a plastic mounting sleeve that slides onto the shaft and has flexible tabs that snap into the retention groove. Although this type of knob is not readily removable, it can be removed with manual effort. As such, I have found that this type of stick shift knob is not securely mounted on the stick shift shaft of the vehicle and may be prone to accidental removal during use. Therefore the mounting structure of this type of knob is not desirable.

Vehicle owners are sometimes dissatisfied with the aesthetic appearance of the stick shift knob provided by the manufacturer. As such, it may be desirable to remove and replace the stick shift knob. Aftermarket knobs with alternative designs and aesthetic appearances are available. Such aftermarket knobs utilize the retention structure (e.g. the retention groove) provided on the stick shift shaft. One known aftermarket knob includes a mounting sleeve having a metal snap ring carried on the inside surface of the mounting sleeve. The metal snap ring will easily snap into the retention groove, however, the knob is virtually permanently secured to the stick shift shaft and not manually removable without tools or excessive force. As such, this is not desirable for vehicle owners who may wish to place other stick shift knobs on the stick shift shaft.

### BRIEF SUMMARY OF THE INVENTION

In light of the above, it is a general objective of the present invention to provide a stick shift knob assembly that avoids the problems of the prior art.

In accordance with these and other objectives, the present invention is directed toward a quick attach and release mechanism for shift knobs which may utilize the existing groove retention structure on stick shift shafts of vehicles. An embodiment of the present invention comprises a shift knob secured to a mounting sleeve. The mounting sleeve slides on the stick shift shaft. The mounting sleeve carries an attach and release coupler comprising a hand grip and at least one retainer, the hand grip is manually movable between release and attach positions relative to the mounting sleeve and controls the position of the at least one retainer. Specifically, the hand grip positions the at least one retainer in the annular retention groove when in the attach position to secure the shift knob to the stick shift shaft. The hand grip causes the at least one retainer to withdraw from the annular retention groove when in the release position to allow for removal of the shift knob from the stick shift shaft.

According to a preferred embodiment of the present invention, a shift knob assembly comprises a mounting sleeve secured to the shift knob. The mounting sleeve mounts or slides closely onto the stick shift for mounting and support. The mounting sleeve has at least one hole extending laterally through the sleeve that aligns with the retaining groove of the stick shift shaft. The hole has a retaining lip at one end to retain the ball. A retaining sleeve coaxial about the mounting sleeve is axially slidable relative to the mounting sleeve between attach and release positions. The retaining sleeve has an eccentric surface acting upon the retaining ball during the transition between the release and attach positions to control whether the retaining ball engages or disengages the retention groove of the stick shift shaft. A biasing mechanism such as a coil spring or other resilient member urges the retaining sleeve toward the attach position.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an exploded isometric view of a stick shift assembly according to a preferred embodiment of the present invention.

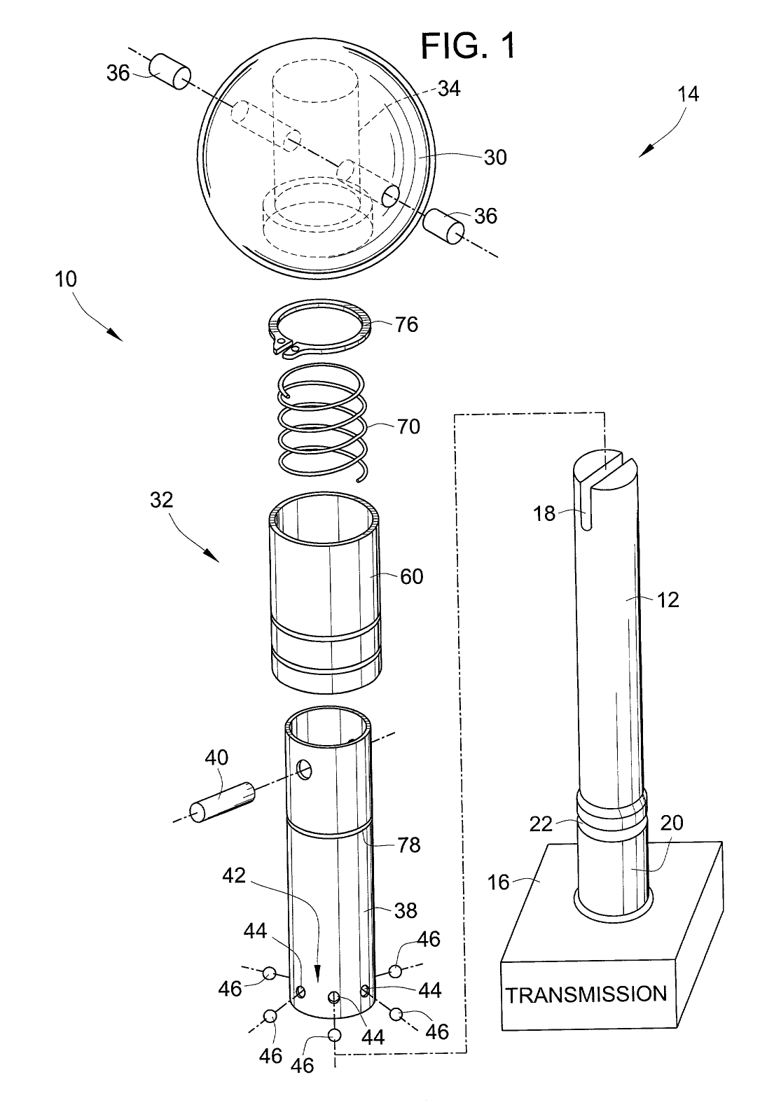

FIG. 2 is a side view of the stick shift assembly of FIG. 1 as assembled.

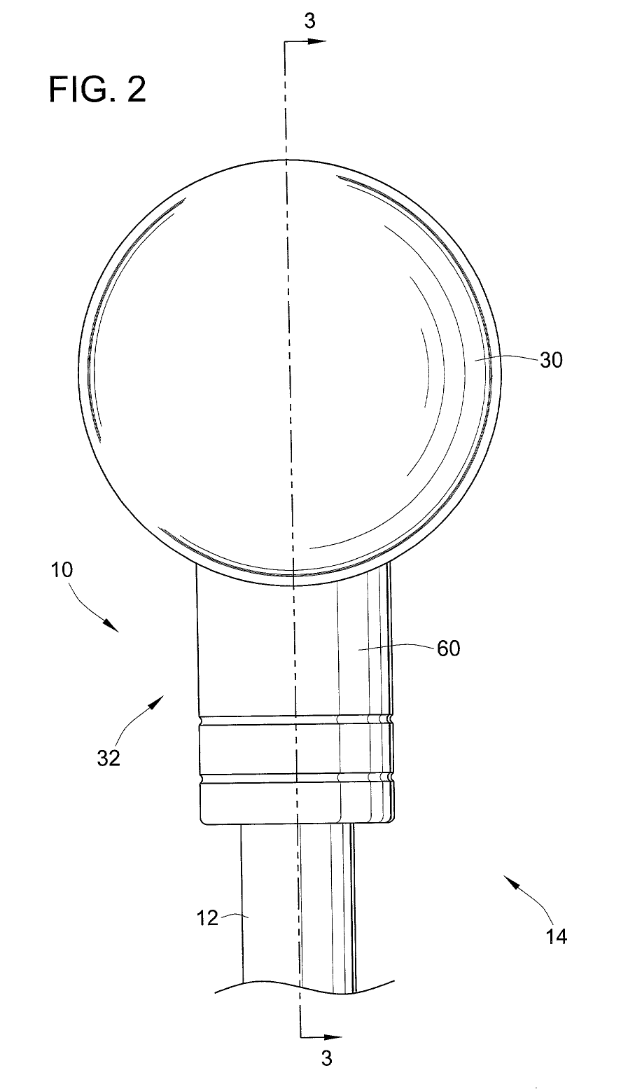

FIG. 3 is a cross section of the stick shift assembly shown in FIG. 2 shown in an attach position to secure the shift knob to the stick shift shaft.

FIG. 4 is a cross section of the stick shift assembly shown in FIG. 3, but in a release position to allow for removal of the shift knob from the stick shift shaft.

FIG. 5 is an enlarged view of a portion of FIG. 3.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

For purposes of references, a preferred embodiment of the present invention has been depicted as a shift knob assembly 10 for mounting to a stick shift shaft 12, the combination of which provides a stick shift assembly 14 for shifting the gears of a vehicle transmission 16.

The depicted shaft 12 represents the common and existing shaft structure common on many of the existing vehicles, such as BMW® Roadsters. One end of the shaft 12 is coupled to the vehicle transmission while the other end provides an axially extending slot 18. The shaft 12 also includes an enlarged base portion 20 and a retention groove 22 or other similar retention structure (e.g. such as a rib) near the base portion 20.

The shift knob assembly 10 includes a shift knob 30 and an attach and release mechanism 32. The shift knob 30 provides a handle to be manually grasped to allow the driver of the vehicle to shift between different gears. The shape of the shift knob 30 can take many different forms to provide a desired aesthetic appearance. The knob 30 has a cylindrical cavity 34 that receives the projecting end of the attach and release mechanism 32. The knob 30 may be mounted to the attach and release mechanism 32 in a number of ways such as set screws 36 or fasteners as shown, or other means such as gluing or even integrally connecting the knob and the end portion of the attach and release mechanism.

In accordance with the present invention, the attach and release mechanism 32 of the disclosed embodiment provides for easy attachment and detachment of the shift knob 30 when desired. In the disclosed embodiment, the attachment and release mechanism comprises a mounting sleeve 38 that slides closely over the stick shift shaft 12 to provide radial support. One end of the mounting sleeve 38 slides into the cylindrical cavity 34 of the shift knob 30 and is secured thereto. At this end, the mounting sleeve 38 may have a pin 40 that is mounted laterally through the middle of the sleeve 38 and fits into the end slot 18 of the shaft 12 to provide a means for preventing relative rotation between the shaft 12 and the shift knob 30. At the other end, a ball cage 42 is formed into the mounting sleeve 38.

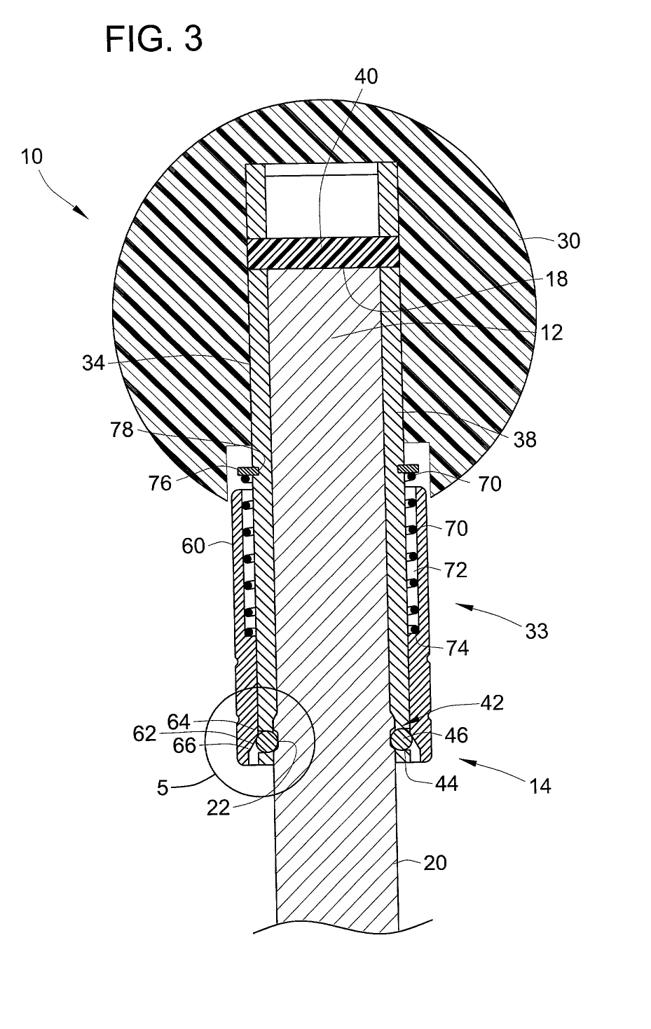

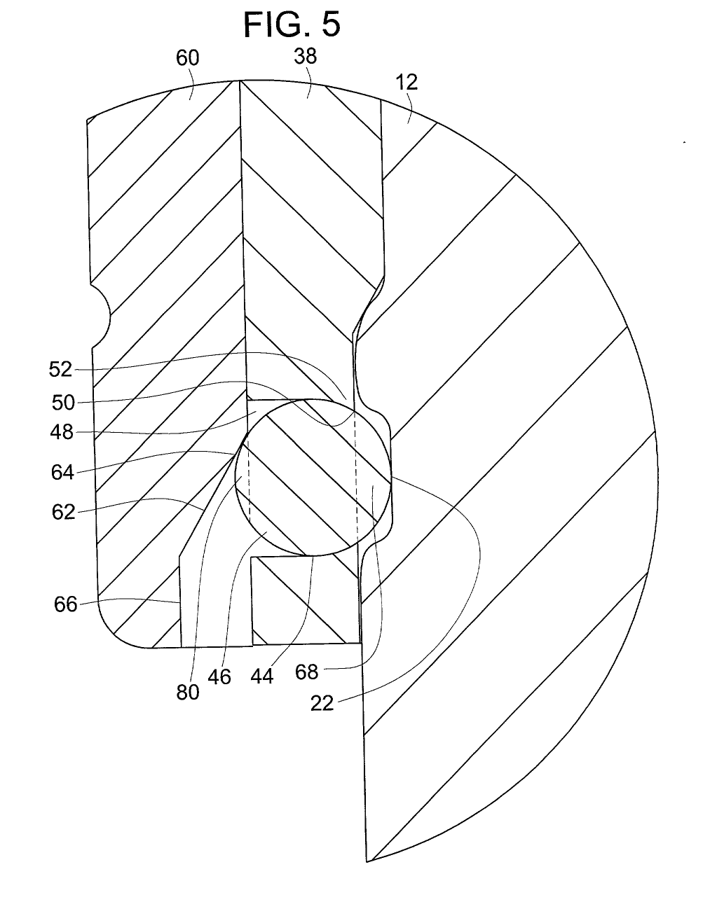

The ball cage 42 includes at least one and preferably several holes 44 extending laterally through the cylindrical wall of the mounting sleeve 38. The holes 44 are aligned in the plane perpendicular to the axis and at a spaced angular orientation. The holes 44 receive balls 46. When the shift knob assembly 10 is assembled as shown in FIGS. 3-5, the balls are trapped in the holes 44. Referring to FIG. 5, the holes 44 include a larger diameter outer opening 48 to allow for insertion of balls 46 and a smaller diameter inner opening 50 to provide a retaining lip 52 to provide for the retention of the balls 46.

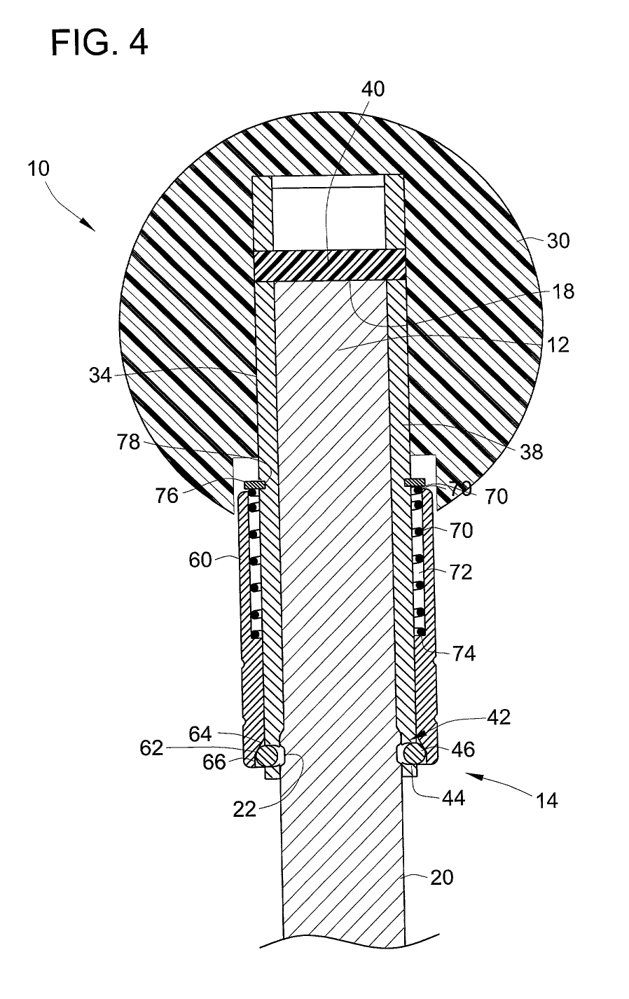

A retaining sleeve 60 is provided coaxial about the mounting sleeve 38. The retaining sleeve 60 is axially slidable relative to the mounting sleeve 38 between attach and release positions as shown in FIGS. 3 and 4 respectively. Referring again to FIG. 5, the retaining sleeve 60 includes an eccentric surface 62 along its inner surface at a location over the ball cage 42. The eccentric surface 62 includes a smaller diameter portion 64 that urges the balls 46 radially inward against the retaining lip 52 and a larger diameter portion 66 that allows the balls to expand radially outwardly. The smaller diameter portion 64 urges the balls 46 against or towards the retaining lips 52 of the holes 44 such that a spherical cap portion 68 of each retaining ball 46 projects radially inward beyond the inner cylindrical surface of the mounting sleeve 38. When the shift knob assembly 10 is mounted on the stick shift shaft 12, the spherical cap portion 68 of each ball projects into and engages the retaining groove 22. The larger diameter portion 66 allows the balls 46 to spread radially outward in the respective holes 44 such that the spherical cap portion 68 of the balls 46 do not project beyond the inner cylindrical surface of the mounting sleeve 38.

The attach and release mechanism 32 may also include a biasing mechanism such as a coil spring 70 or other resilient member to bias the retaining sleeve 60 toward the attach position shown in FIG. 3. In the disclosed embodiment, the coil spring 70 is coaxial about the mounting sleeve 32 and contained partly within a spring chamber 72 provided by a recess in the inner surface of the retaining sleeve 60. The retaining sleeve 60 includes an annular shoulder 74 at the end of the spring chamber 72 that acts upon the end of the coil spring 70. The other end of the coil spring 70 is supported by a retaining structure on the mounting sleeve 38, shown herein as a snap ring retainer clip 76. The retainer clip 76 snaps into an annular groove 78 formed into the mounting sleeve 38.

The sliding movement of the attach and release mechanism 32 between attach and release positions may also be limited. When in the attach position shown in FIGS. 3 and 5, the balls 46 have a second spherical cap portion 80 projecting radially outwardly from the outer openings 48 of the holes that engage the larger diameter portion 66 of the retaining sleeve 60 at least axially in part to prevent the retaining sleeve from sliding off of the end of the mounting sleeve 38. The balls 46 thus also act as a mechanical stop to limit movement of the retaining sleeve in one axial direction. In the other axial direction, the retainer clip 76 limits the axial movement to prevent retaining sleeve from sliding so far as to uncover the balls 46. This ensures that the balls are trapped in the lateral holes 44 and do not fall out during movement to the release position.

In operation, the attach and release mechanism 32 is manually controlled by sliding of the retaining sleeve 60 relative to the mounting sleeve 38. The retaining sleeve 60 acts as a hand grip which can be easily manually actuated against the action of the coil spring 70 to selectively control the group radius of the balls 46 which act as retainers, and thereby switch the attach and release mechanism 32 between the attach and release positions shown in FIGS. 3 and 4. During installation of the shift knob assembly 10 on a stick shift shaft 12, the attach and release mechanism 32 is initially positioned in the release position to allow the mounting sleeve 38 to slidably mount or slip easily over shaft 12. It should be noted that the spring 70 provides a biasing force that can be easily overcome manually. Once the balls 46 come into alignment with the retention groove 22, the attach and release mechanism 32 can be released into the attach position whereby the spherical cap portions 68 of the balls engage the retention groove 22 and thereby secure the shift knob assembly 10 to the shaft 12 in a non-removable manner. In this position, not even excessive manual force exerted during shifting of the transmission will cause accidental removal of the shift knob assembly 10 from the stick shift shaft 12. However, the shift knob assembly 10 can be easily removed from the shaft 12 by simply gripping and sliding the retaining sleeve 60 again to the release position, but this time to withdraw the balls 46 from the retention groove 22 and then pulling or sliding the shift knob assembly 10 off of the shaft 12.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A stick shift assembly for a vehicle, comprising in combination:
a stick shift shaft coupled to the transmission of the vehicle, the stick shift shaft defining an annular retention groove;
a shift knob secured to a mounting sleeve, the mounting sleeve being received on the stick shift shaft, the mounting sleeve carrying an attach and release coupler comprising a hand grip and at least one retainer, the hand grip movable between release and attach positions relative to the mounting sleeve, the hand grip controlling the position of the at least one retainer positioning the at least one retainer in the annular retention groove when in the attach position to secure the shift knob to the stick shift shaft and withdrawing the at least one retainer from the annular retention groove when in the release position to allow for removal of the shift knob from the stick shift shaft.

2. The stick shift assembly of claim 1, further comprising a biasing mechanism urging the hand grip toward the attach position.

3. The stick shift assembly of claim 1 wherein the hand grip comprises a retaining sleeve coaxial about the mounting sleeve and slidable relative to the mounting sleeve.

4. The stick shift assembly of claim 3 wherein the at least one retainer comprises at least one retaining ball positioned in at least one lateral hole extending through the mounting sleeve, the retaining sleeve having an eccentric controlling the position of the at least one retaining ball, the retaining sleeve urging the at least one ball radially into the retention groove when in the attach position and allowing the at least one ball to disengage the retention groove when in the release position.

5. The stick shift assembly of claim 4 further comprising a coil spring coaxial about the mounting sleeve and supported by the mounting sleeve urging the retaining sleeve towards the attach position.

6. The shift knob assembly of claim 5 further comprising a snap ring secured to the mounting sleeve acting upon one end of the coil spring, the retaining sleeve including a segment coaxial about the spring and acting upon a second end of the coil spring.

7. The shift knob assembly of claim 6 wherein a plurality of the retaining balls and a plurality of the holes are provided, the plurality of retaining balls and holes being located at spaced angular positions about the mounting sleeve

8. The stick shift assembly of claim 1 wherein the shift knob is manually non-removable from the stick shift shaft when in the attach position and manually removable when in the release position

9. A shift knob assembly for a stick shaft of a vehicle, a stick shift shaft coupled to the transmission of the vehicle, the stick shift shaft defining an annular retention groove, comprising:
a shift knob;
a mounting sleeve secured to the shift knob, the mounting sleeve being adapted to slide closely onto the stick shift shaft, the mounting sleeve having at least one hole extending laterally through sleeve, the at least one hole having a larger opening a first end thereof and a smaller opening at a second end thereof to provide a retaining lip, the at least one hole adapted to align with the retaining groove when the mounting sleeve is received on the stick shift shaft;
at least one retaining ball retained in the at least one hole by the retaining lip at the second end;
a retaining sleeve coaxial about the mounting sleeve and axially slidable relative to the mounting sleeve between attach and release positions, the retaining sleeve having an eccentric surface acting upon the retaining ball during the transition between the release and attach positions, the retaining sleeve urging the ball radially inwardly when in the attach position such that a portion of the retaining ball projects inwardly beyond the retaining lip such that the at least one retaining ball engages the retention groove when aligned with the retaining groove; and
a biasing mechanism urging the retaining sleeve toward the attach position.

10. The shift knob assembly of claim 9 wherein the biasing mechanism comprises a coil spring coaxial about the mounting sleeve and supported by the mounting sleeve.

11. The shift knob assembly of claim 10 further comprising a snap ring secured to the mounting sleeve acting upon one end of the coil spring, the retaining sleeve including a segment coaxial about the spring and acting upon a second end of the coil spring.

12. The shift knob assembly of claim 9 wherein a plurality of the retaining balls and a plurality of the holes are provided, the plurality of retaining balls and holes being located at spaced angular positions about the mounting sleeve.

13. The stick shift assembly of claim 9 wherein the shift knob is manually non-removable from the stick shift shaft when in the attach position and manually removable when in the release position.
